(19) United States
(12) Patent Application Publication
(10) Pub. No.: US 2024/0140736 A1
(43) Pub. Date: May 2, 2024

(54) SYSTEMS AND METHODS FOR AUTOMATED PACKAGING AND PROCESSING WITH OBJECT PLACEMENT POSE CONTROL

(71) Applicant: Berkshire Grey Operating Company, Inc., Bedford, MA (US)

(72) Inventors: Alex Benjamin SHER, Creve Coeur, MO (US); Thomas Joseph Culliton, Arlington, MA (US); Jeremy Saslaw, Cambridge, MA (US); Ashwin Deshpande, Lexington, MA (US); Christopher Geyer, Arlington, MA (US)

(21) Appl. No.: 18/384,258

(22) Filed: Oct. 26, 2023

Related U.S. Application Data
(60) Provisional application No. 63/419,932, filed on Oct. 27, 2022.

(51) Int. Cl. B65G 61/00; B25J 9/10; G06T 7/70

(52) U.S. Cl. CPC B65G 61/00; B25J 9/1005; G06T 7/70

(57) ABSTRACT

A method of processing objects is disclosed. The method includes grasping an object with an end-effector of a programmable motion device, determining an estimated pose of the object as it is being grasped by the end-effector, determining a pose adjustment for repositioning the object for placement at a destination location in a destination pose, determining a pose adjustment to be applied to the object, and placing the object at the destination location in a destination pose in accordance with the pose adjustment.

### PRIORITY

The present invention claims priority to U.S. Provisional Patent Application No. 63/419,932 filed Oct. 27, 2022, the disclosure of which is hereby incorporated by reference its entirety.

### BACKGROUND

The invention generally relates to automated sortation and other processing systems, and relates in particular to automated systems for handling and processing objects such as parcels, packages, articles, goods etc. for e-commerce distribution, sortation, facilities replenishment, and automated storage and retrieval (AS/RS) systems.

Shipment centers for packaging and shipping a limited range of objects, for example, from a source company that manufactures the objects, may require only systems and processes that accommodate the limited range of the same objects repeatedly. Third party shipment centers on the other hand, that receive a wide variety of objects, must utilize systems and processes that may accommodate the wide variety of objects.

In e-commerce order fulfillment centers, for example, human personnel pack units of objects into shipping containers like boxes or polybags. One of the last steps in an order fulfillment center is packing one or more objects into a shipping container or bag. Units of an order destined for a customer are typically packed by hand at pack stations. Order fulfillment centers do this for a number of reasons.

Objects typically need to be packed in shipping materials. Objects need to be put in boxes or bags to protect the objects, but are not generally stored in the materials in which they are shipped, but rather need to be packed on-the-fly after an order for the object has been received.

Handling a wide variety of objects on common conveyance and processing systems however, present challenges. particularly where objects have any of low pose authority or low placement authority. Pose authority is the ability to place an object into a desired position and orientation (pose), and placement authority is ability of an object to remain in a position and orientation at which it is placed. If for example, an object with low pose authority (e.g., a floppy bag) or low placement authority (e.g., a cylindrical object) is to be moved on a conveyance system that may undergo a change in shape and/or linear or angular acceleration or deceleration, the object may fall over and/or may fall off of the conveyance system.

These requirements become more challenging as the number of goods and the number of destination locations increase, and further where the system needs to place objects into relatively small places such as cubbies or into bags or slots. There is a need therefore, for an automated system for handling objects in object processing systems with low pose authority and/or low placement authority, and further a need for an automated system that may more easily and readily place objects into containers, cubbies, bags or slots.

### SUMMARY

In accordance with an aspect, the invention provides a method of processing objects that method includes grasping an object with an end-effector of a programmable motion device, determining an estimated pose of the object as it is being grasped by the end-effector, determining a pose adjustment for repositioning the object for placement at a destination location in a destination pose, determining a pose adjustment to be applied to the object, and placing the object at the destination location in a destination pose in accordance with the pose adjustment.

In accordance with another aspect, the invention provides a method of processing objects that includes grasping an object with an end-effector of a programmable motion device, determining an estimated pose of the object as it is being grasped by the end-effector, determining estimated joint positions of a plurality of the joints of the programmable motion device associated with the estimated pose of the object, associating the estimated pose with the estimated joint positions to provide placement pose information, and placing the object at the destination location in a destination pose based on the placement pose information.

In accordance with a further aspect, the invention provides an object processing system for processing objects that includes an end-effector of a programmable motion device for grasping an object, at least one pose-in-hand perception system for assisting in determining an estimated pose of the object as held by the end-effector, a control system for determining estimated joint positions of a plurality of the joints of the programmable motion device associated with the estimated pose of the object, and for associating the estimated pose with the estimated joint positions to provide placement pose information, and a destination location at which the object is placed in a destination pose based on the placement pose information.

### BRIEF DESCRIPTION OF THE DRAWINGS

The following description may be further understood with reference to the accompanying drawings in which:

FIG. 1 shows an illustrative diagrammatic view of an object processing system in accordance with an aspect of the present invention;

FIG. 2 shows an illustrative diagrammatic enlarged view of a portion of the system of FIG. 1 showing the pose-in-hand perception system;

FIGS. 3A and 3B show illustrative diagrammatic underside views of an object as it is being held by the end-effector of FIG. 1, showing the object being held in a stationary first pose-in-hand location (FIG. 3A) and showing the object being held in a stationary second pose-in-hand location (FIG. 3B);

FIGS. 4A and 4B show illustrative diagrammatic side views the object of FIGS. 3A and 3B showing the object at a first position prior to perception data capture while moving (FIG. 4A) and showing the object at a second position following perception data capture while moving (FIG. 4B);

FIG. 5 shows an illustrative diagrammatic view of an object placement pose control system in accordance with an aspect of the present invention used with a box packaging system;

FIGS. 6A and 6B show illustrative diagrammatic plan views of an object overlying a section of box packaging showing the section of box packaging material prior to being cut (FIG. 6A) and after being cut (FIG. 6B);

FIGS. 7A and 7B show illustrative diagrammatic plan views of another object overlying a section of box packaging showing the section of box packaging material prior to being cut (FIG. 7A) and after being cut (FIG. 7B);

FIG. 8 shows an illustrative diagrammatic view of an end-effector used in accordance with an aspect of the present invention with the vacuum cup attached in a coordinate environment;

FIG. 9 shows an illustrative diagrammatic view of an object in the coordinate environment shown in various face-up positions;

FIGS. 10A and 10B show illustrative diagrammatic views of the end-effector of FIG. 8 showing an object having been placed with the smallest face up on a conveyor (FIG. 10A) and showing the object subsequently falling as the conveyor moves (FIG. 10B);

FIGS. 11A and 11B show illustrative diagrammatic views of the end-effector of FIG. 8 showing an object having been placed with the smallest face up rotated on a conveyor (FIG. 11A) and showing the object subsequently falling as the conveyor risking falling off of the conveyor (FIG. 11B);

FIGS. 12 A and 12B show illustrative diagrammatic views of an object being placed onto a conveyor (FIG. 12A) such that its center-of-mass is offset by a trailing distance from an area of contact on a moving conveyor providing that the object undergoes a controlled fall on the conveyor (FIG. 12B);

FIGS. 13A and 13B show illustrative diagrammatic views of an object being placed onto a conveyor (FIG. 13A) such that its center-of-mass is offset by a distance from an area of contact that is orthogonal with respect to the direction of movement of the conveyor providing that the object undergoes a controlled fall on the conveyor (FIG. 13B);

FIG. 14 shows an illustrative diagrammatic view of an object being placed into a shallow bin so as to initiate a controlled fall;

FIG. 15 shows an illustrative diagrammatic view of an object being placed into a taller bin that already includes other objects so as to initiate a controlled fall;

FIG. 16 shows an illustrative diagrammatic view of a portion of an object processing system that includes bags into which objects are dropped, with an object being grasped on its largest face up;

FIG. 17 shows an illustrative diagrammatic view of the object processing system that includes bags as shown in FIG. 16, with the object being grasped on its largest face up and being positioned to drop the object into a bag;

FIG. 18 shows an illustrative diagrammatic view of a portion of an object processing system that includes an auto-bagging system into which objects are dropped, with an object being grasped on its largest face up;

FIG. 19 shows an illustrative diagrammatic view of the object processing system that includes the auto-bagging system as shown in FIG. 18, with the object being grasped on its largest face up and being positioned to drop the object into the opening of the auto-bagging system;

FIG. 20 shows an illustrative diagrammatic elevational view of an object being held by an end-effector with the largest-face-up that is to be moved to a designated container of known dimensions;

FIG. 21 shows an illustrative diagrammatic plan view of a plurality of orientations of the object of FIG. 20 that as it may be placed into the designated container of FIG. 20;

FIG. 22 shows an illustrative diagrammatic rear view of an object processing system in accordance with a further aspect of the present invention that includes an array of vertically stacked cubbies;

FIG. 23 shows an illustrative diagrammatic enlarged front view of the system of FIG. 20;

FIGS. 24A and 24B show illustrative diagrammatic plan views of an object processing system in accordance with an aspect of the present invention in which the system attempts to place an object into a cubby wherein the object is not aligned with the opening (FIG. 24A) and in which the system places an object into a cubby wherein the object is aligned with the opening (FIG. 24B);

FIGS. 25A and 25B show illustrative diagrammatic plan views of an object processing system in accordance with an aspect of the present invention in which an object is being loaded into a container with like objects is a first position (FIG. 25A) and in which the object is being loaded in to a container with like objects is a second position (FIG. 25B);

FIGS. 26A and 26B show illustrative diagrammatic side views of an object held by the largest face in a first orientation is being placed onto a surface for repositioning (FIG. 26A) and the object as re-grasped by the end-effector following repositioning (FIG. 26B);

FIGS. 27A and 27B show illustrative diagrammatic plan views of another object processing system in accordance with another aspect of the present invention in which an object is being loaded into a container with like objects is a first position (FIG. 27A) and in which the object is being loaded into the container with like objects is a second position (FIG. 27B);

FIGS. 28A and 28B show illustrative diagrammatic side views of an object held by the largest face in a second orientation is being placed onto a surface for repositioning (FIG. 28A) and the object as re-grasped by the end-effector following repositioning (FIG. 28B); and

FIGS. 29A and 29B show illustrative diagrammatic plan views of a further object processing system in accordance with another aspect of the present invention in which an object is being loaded into a container with like objects is a first position (FIG. 29A) and in which the object is being loaded into the container with like objects is a second position (FIG. 29B).

The drawings are shown for illustrative purposes only.

### DETAILED DESCRIPTION

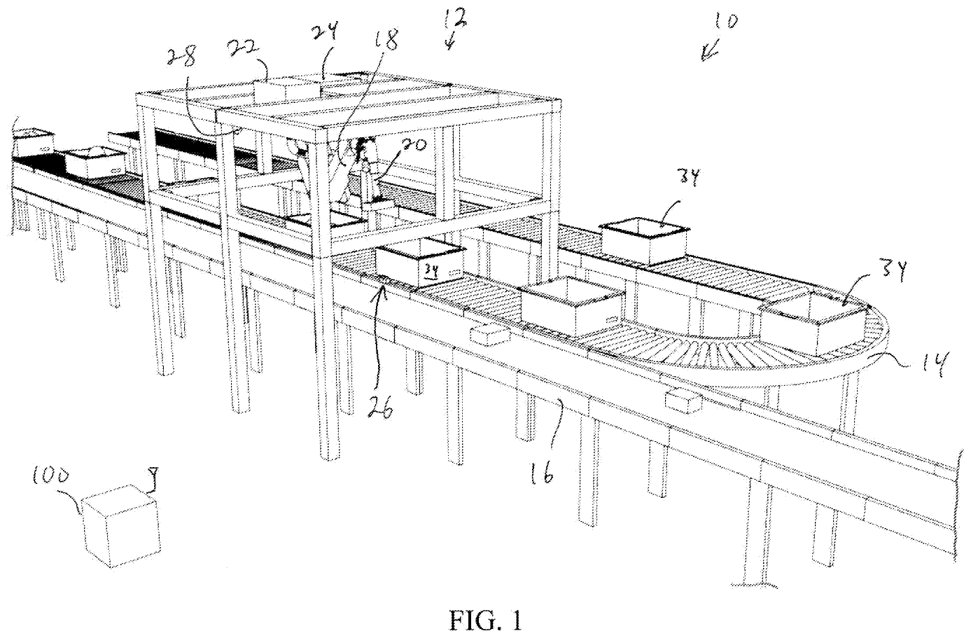

In accordance with various aspects, the invention provides an object processing system 10 that includes a processing station 12 in communication with an input conveyance system 14 and an processing conveyance system 16 as shown in FIG. 1. The processing station 12 includes a programmable motion device 18 with an attached end-effector 20 at a distal end thereof. The end-effector 20 may be coupled (e.g., via hose) to a vacuum source 22, and the operation of the programmable motion device may be provided by a one or more computer processing systems 24 in communication with one or more control systems 100 in communication with all perception units, conveyors and further processing system disclosed herein.

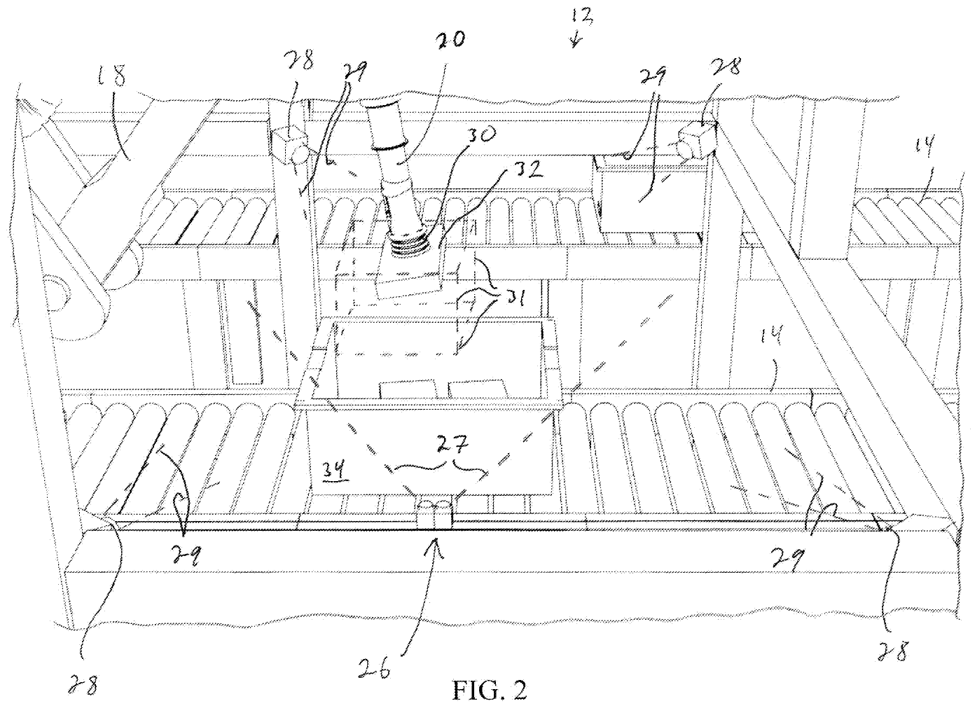

The object processing system 10 further includes a pose-in-hand perception system 26 that may be employed to determine a pose of an object held by the end-effector 20. FIG. 2 shows the pose-in-hand perception system 26 (with one or more perception units) that is directed upward with a viewing area generally diagrammatically indicated at 27. The perception system 26 may include any of 2D or 3D sensors and/or cameras that calculate a virtual bounding box around the point cloud data captured (e.g., by one or more 3D cameras) with the constraint that the bounding box is in contact with the gripper. Object geometry or dimensions may or may not be known a priori. If known, the geometry or dimensions could be used a priori to fuse with noisy pose-in-hand estimates.

Further perception systems 28 may also be employed for viewing an object on the end-effector 20, each having viewing areas as generally diagrammatically indicated at 29. The end-effector 20 includes a vacuum cup 30, and the perception systems 26, 28 are directed toward a virtual bounding box 31 that is defined to be in contact with the vacuum cup 30. An object 32 is grasped and moved from an input container 34 on the input conveyance system 14, and the object is moved over the pose-in-hand perception system 26.

In accordance with certain aspects, the programmable motion device 18 may stop moving when the object is over the pose-in-hand perception system 26 such that the pose of the object 32 on the vacuum cup 30 may be determined. The pose-in-hand as determined is associated with joint positions of each of the joints of the articulated arm sections of the programmable motion device. In this way, the system records not only the pose-in-hand of the object as held by the gripper, but also the precise position of each of the articulated sections of the programmable motion device. In particular, this means that the precise position of the end-effector 20 and the gripper 30 is known. Knowing these positions (in space), the system may be subtracted from any perception data as being associated with the object. The system may also therefore know all locations, positions and orientations in which the object may be moved to, and oriented in, the robotic environment. The perception units 26, 28 are provided in known, extrinsically calibrated positions. Responsive to a determined pose-in-hand, the system may move an object (e.g., 32) to a desired location (e.g., a bin or a conveyor surface) in any of a variety of locations, positions and orientations responsive to the determined pose-in-hand.

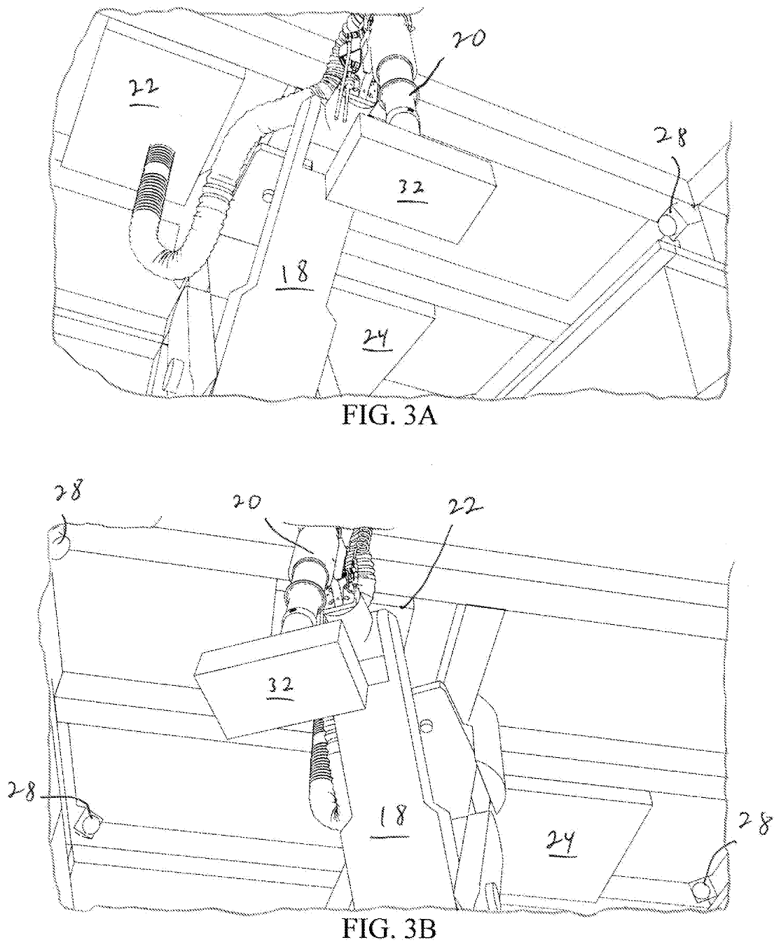

FIGS. 3A and 3B, for example, show underside pose-in-hand views of the object as it is being held by the end-effector. FIG. 3A for example, shows the object 32 as it is being held at a pose-in-hand locations (stationary) by the programmable motion device 18. As the programmable motion device is not moving, data regarding of all joint positions may be readily determined. In accordance with further aspects, the programmable motion device 18 may then move to a secondary position (as shown in FIG. 3B) at which the pose-in-hand is again determined as associated with a further set of data regarding the new joint positions. Robust pose-in-hand data may thereby be determined as associated with specific joint positions of the programmable motion deice 18, thereby providing information regarding volume in space occupied by the end-effector and the gripper, and providing information regarding potentially available (and unavailable) positions and orientations of the arm sections of the programmable motion device 18.

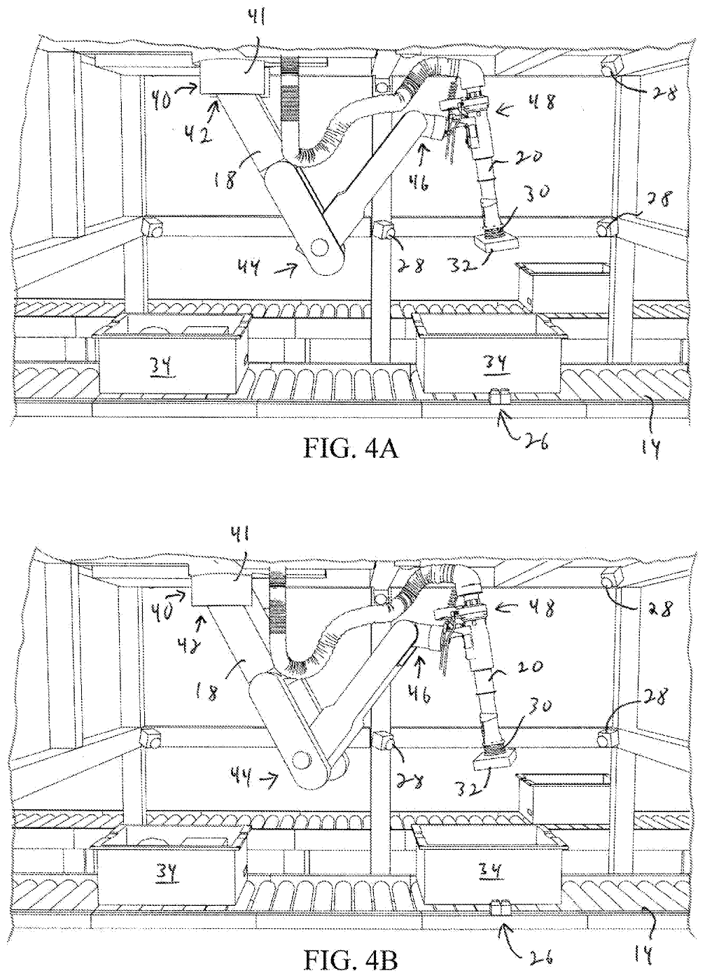

In accordance with further aspects, the system may determine pose-in-hand while the object is moving. A challenge however, is that the response time between capturing a pose-in-hand image and determining joint positions of the articulated arm (whether prior to or after the image capture) may introduce significant errors. The system may, in accordance with an aspect, record positions of each joint (e.g., 40, 42, 44, 46, 48) at a time immediately before the perception data capture by the pose-in-hand perception system 26, as well as record positions of each joint (e.g., 40, 42, 44, 46, 48) immediately following the perception data capture. The joints for example, may include joint 40 (rotation of the mount 41 with respect to the support structure), joint 42 (pivot of the first arm section with respect to the mount 41), joint 44 (pivot of arm sections), joint 46 (pivot of arm sections), and joint 48 (rotation and yawing of the end-effector). FIG. 4A for example, shows the system with the programmable motion device 18 at a first position prior to perception data capture, and FIG. 4B shows the programmable motion device 18 at a second position following perception data capture. The system may then interpolate the sets of joints positions to estimate the positions of each joint at the time of perception data capture. In particular, the system may interpolate a joint position for each of joints 40, 42, 44, 46 and 48 between the respective joint positions before perception data capture (e.g., FIG. 4A) and respective joint positions after perception data capture (e.g., FIG. 4B).

In accordance with further aspects, trajectories from the pose-in-hand node to placement positions can be pre-computed. In particular, the system may discretize the desired placement position (x,y) of the center of the where the gripper is positioned and its orientation. Then for each of the Xₓ Yₓ θ possibilities the system may pre-compute the motion plans. Then when the system looks up (x,y, θ) in lookup table, the system may interpolate or blend motion plans between two or more nearby pre-computed trajectories in order to increase placement accuracy.

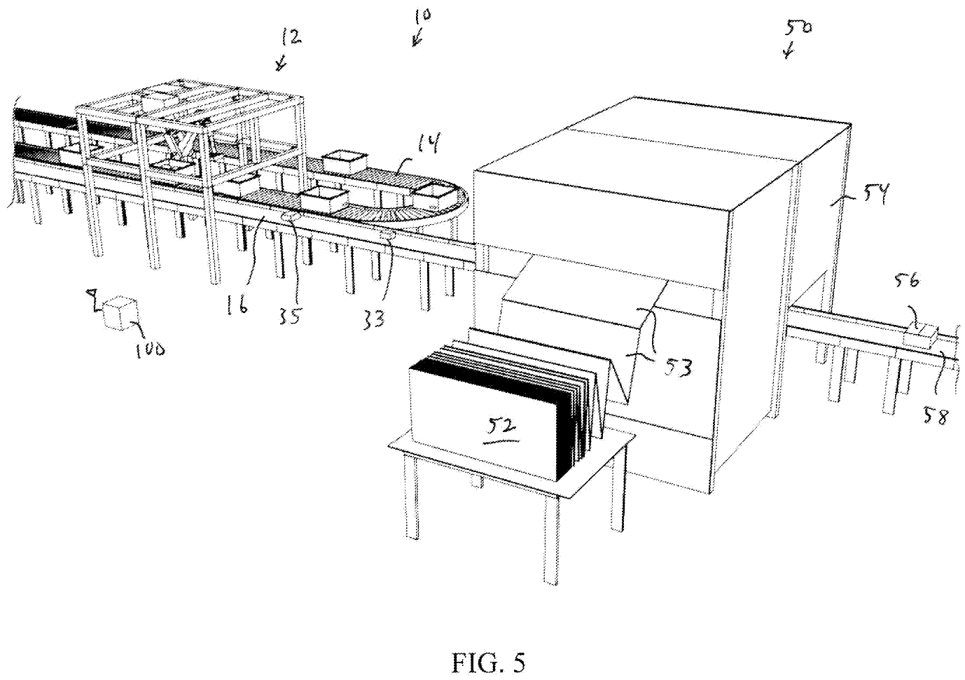

The object placement pose control system may be used with a box packaging system 50 as shown in FIG. 5. The box packaging system 50 may receive objects (e.g., 33, 35) that have been purposefully positioned on the conveyor 16, and individually wrap each object in box packaging material 52 that is fed as a continuous stack of stock material into the box material cutter and assembler 54. See for example, a CMC CartonWrap system sold by CMC S.P.A of Perugia, Italy. Objects are received (e.g., on a conveyor belt) and wrapped with a packaging material such as carboard. Packaged objects (e.g., 56) are then provided on an output section 58 of the conveyor. A goal of such systems is to not only cleanly and protectively package each of an input stream of objects, but also to use a minimal amount of box packaging material (e.g., cardboard) in the process. The box packaging material 52 may be provided in panels (e.g., 53) that are fed into the box material cutter and assembler 54. The panels 53 may be releasably coupled together such that they are readily separable from one another. Within the box material cutter and assembler 54, the panels are cut into required sizes to form a box around each individual object.

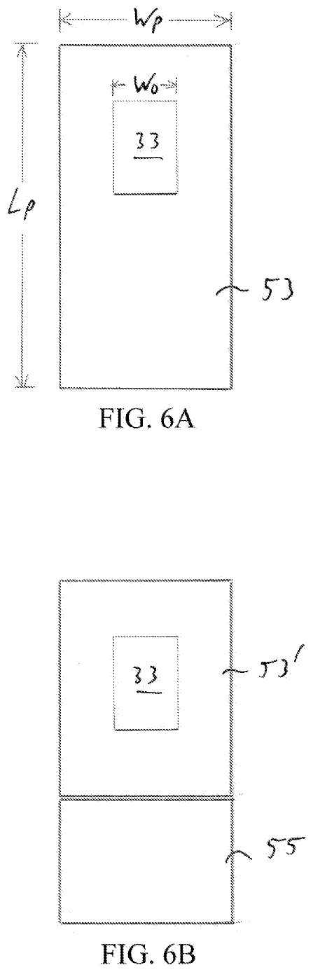

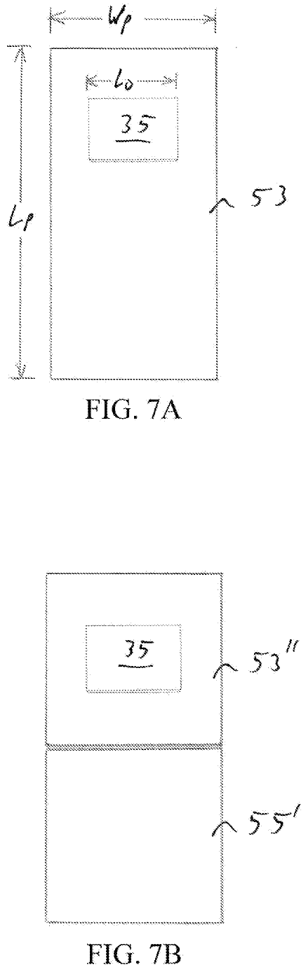

By determining the pose-in-hand of objects as they are held, the objects may be placed on to the conveyor (e.g., 16) is an orientation designed to minimize waste of the box packaging material. FIG. 6A for example, shows an object 33 placed lengthwise and overlying (diagrammatically) a section 53 of the box packaging material. With the object placed lengthwise, the panel 53 may be cut in a way that produces the smaller panel 53′ and extra material 55 as shown in FIG. 6B. FIG. 7A shows an object 35 placed widthwise and overlying (diagrammatically) a section 53 of the box packaging material. With the object placed widthwise, the panel 53 may be cut in a way that produces an even smaller panel 53″ and larger amount of extra material 55′ as shown in FIG. 7B. Depending on the system employed, the amount of unused material (waste) may be minimized. If however, the unused material is determined to be of a useful size, the unused material from one cut may be used in connection with packaging a different object. In this case, the system may choose object orientations that maximize the amount of usable-size cut panels.

The determination of whether an object is placed lengthwise or widthwise on a conveyor depends on the particular application, but having determined the pose-in-hand, the system may properly feed objects to a box packaging system (e.g., 50). Certain rules may be developed, such as not putting objects widthwise where the width of the object W_{O} is larger than a panel width W_{P}. Further rules may include: if W_{O}+2*H_{O}+margin>W_{P}, then place the object lengthwise (as shown in FIG. 6A), and if W_{O}+2*H_{O}+margin<W_{P}, then place the object widthwise (as shown in FIG. 7A), where H_{O} is the height of the object. The system provides a closed-loop placement system that is based on pose-in-hand analysis at the time of processing each object. The objects may be provided in heterogeneous or homogeneous totes, and may be placed on the conveyor in advance of the box packaging system in a way that minimizes usage of box material (e.g., cardboard) stock by acquiring and using pose-in-hand analyses to properly place the objects. In further applications such as with heterogeneous totes, the system may further include additional scanners (e.g., fly-by) to identify SKUs or other barcode information regarding the incoming objects.

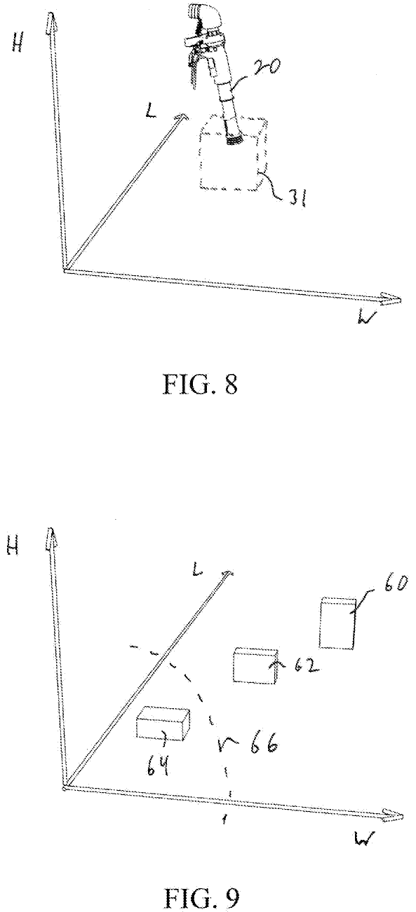

FIG. 8 shows the end-effector 20 with the vacuum cup 30 attached in a coordinate environment showing width (W) or X direction, length (L) or Y direction (and conveyor direction), and height (H) or Z direction. As shown, the system describes a virtual bounding box 31 in the area of the vacuum cup 30 and all point cloud data points are recorded with the pose-in-hand perception system of all points in the point cloud virtual bounding box. If the object were to be placed at a location with the end-effector remaining in much the same position, the object would be described as having a width in the W (or X-direction), a length in the L (or Y-direction or conveyor direction), and a height H (or Z-direction).

This placement orientation defines a toppling risk factor based on both the relative size of the face up as well as the size of the dimension of the object in the conveyor direction. FIG. 9 shows that with a smallest face up (shown at 60), the toppling risk is high, and with the medium face up (shown at 62) the toppling risk is lower. The toppling risk is lowest with the largest face up (shown at 64). A boundary sphere may be described as shown at 66 near the Z direction axis outside of which the toppling risk becomes a higher concern.

When, as described above, objects are taken from an inventory tote or input conveyor and put on a processing conveyor belt for feeding to a subsequent system (such as a box packaging system), the objects must have sufficient placement authority, particularly since the receiving surface (e.g., the processing conveyance system 16) is moving. The system may therefore assess both pose authority and placement authority of a grasped object.

The end-effector of the programmable motion device picks an object from an input area (e.g., out of a tote) and puts it on a belt of the processing conveyance system. If the SKU is packed in the tote in a way that its shortest dimension is vertical, then all should go well. The robot will use pose-in-hand to orient the object (e.g., in a way to minimize cardboard usage) as described above. If however, the object is packed so that the largest dimension is vertical, then there can be a problem in that the SKU may be inclined to topple after being placed on the belt. Toppling could lead to problems not only with subsequent processing stations such as discussed above, but also may cause objects to become jammed in the conveyance systems.

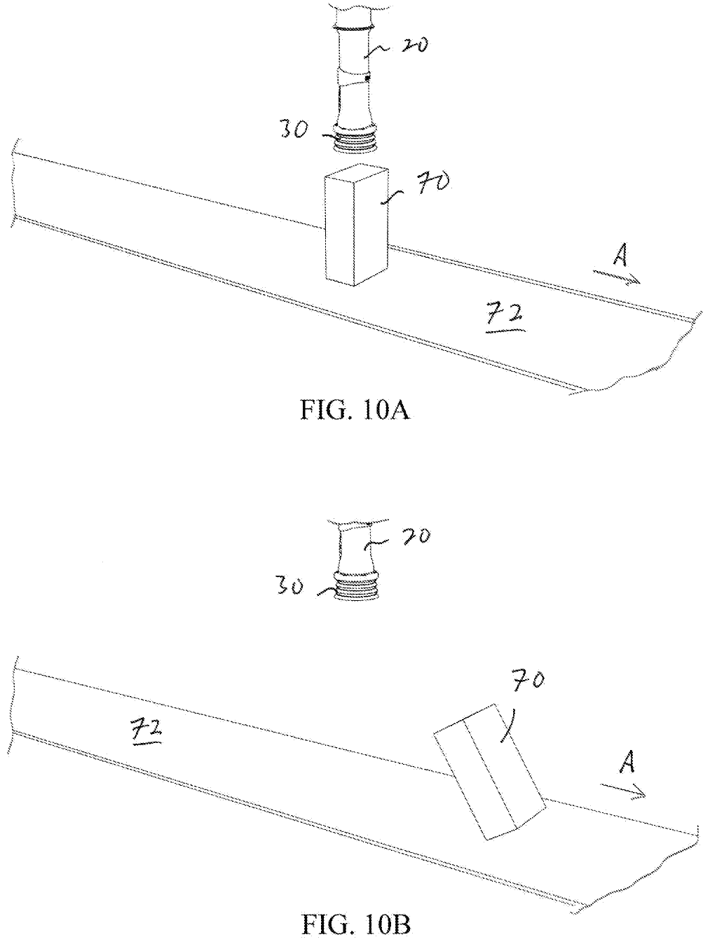

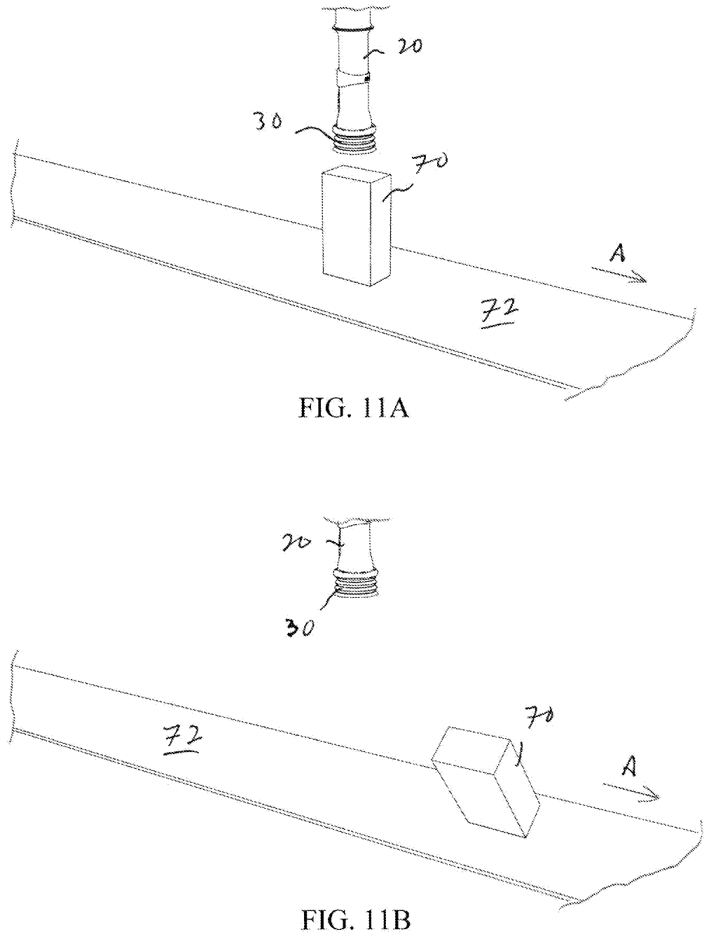

FIG. 10A for example, shows the end-effector 20 of the programmable motion device having just placed an object 70 onto a belt 72 of the processing conveyance system using the vacuum cup 30. As the vacuum cup 30 is moved away from the object, the belt 72 and object 70 moves in the processing direction as shown at A. Due to the largest dimension being vertical and/or due to the movement of the belt (particularly where the smallest dimension is in the direction of the belt), the object may fall over (topple). This may occur as shown in FIG. 10B, or the object may fall forward. Additionally, the object may fall unevenly on its lowest corners causing the object to rotate as it falls. Further, if the object 70 is placed on the belt 72 with its largest dimension being vertical and the smallest dimension being in the cross-direction of the belt (as shown in FIG. 11A), the object 70 may fall over in the cross-direction of the belt (as s shown in FIG. 11B), potentially causing downstream jamming of the processing conveyance system. Any of these events cause uncertainty in the system regarding placement of the object, and this uncertainty thwarts efforts to control the pose of objects during processing.

In accordance with various aspects, the invention provides that an object may either be placed fully in a laying down position or may be placed with its center of mass offset from the point of contact in the direction in which the object is desired to be placed laying down. In accordance with an aspect, therefore, an object may be re-oriented such that is may gently fall (or be placed) so that its shortest dimension is vertical.

With reference again to FIGS. 8 and 9, the system may determine whether the object is being held with the largest face up (LFU), medium face up (LFU) or smallest face up (SFU) from the pose in hand estimates. First, the dimensions (d₁, d₂, d₃) in a product database (when available) may be sorted such that d₃≤d₂≤d₁. The estimated dimensions from the pose-in-hand perception system may then be assigned e₁, e₂, e₃ such that e₁≥e₂ and e₃ is arbitrary. Any of several poses (p₁, p₂, p₃) may be determined as follows:

SFU: e₃>e₁ && e₃<e₂=>d₁,d₃,d₂->p₁

MFU: e₁>e₃ && e₃<e₂ d₂,d₃,d₁->p₂

LFU: e₁>e₂>e₃=>d₁,d₂,d₃->p₃

Pose-in-hand estimates may not always be completely accurate, and in certain applications it may be desired to compare the estimates with the pose-in-hand estimates, or to additionally employ database measurements in evaluating pose-in-hand estimates.

The propensity to topple is further determined by acceleration of the object once transferred to the conveyor (as the end-effector is not traveling with the conveyor), as well any acceleration or deceleration of the conveyor while transporting the object. In accordance with further aspects, the system may move the end-effector with the speed and direction of the conveyor at the time of transfer. The propensity to topple may be determined in a variety of ways, including whether the height dimension is more than twice the width or length (H>2W or H>2L), and this may be modified by any acceleration of the belt as (H>2W−α|Acc| or H>2WL−α|Acc|, where a is a factor that is applied to any acceleration or deceleration |Acc| of the belt during processing.

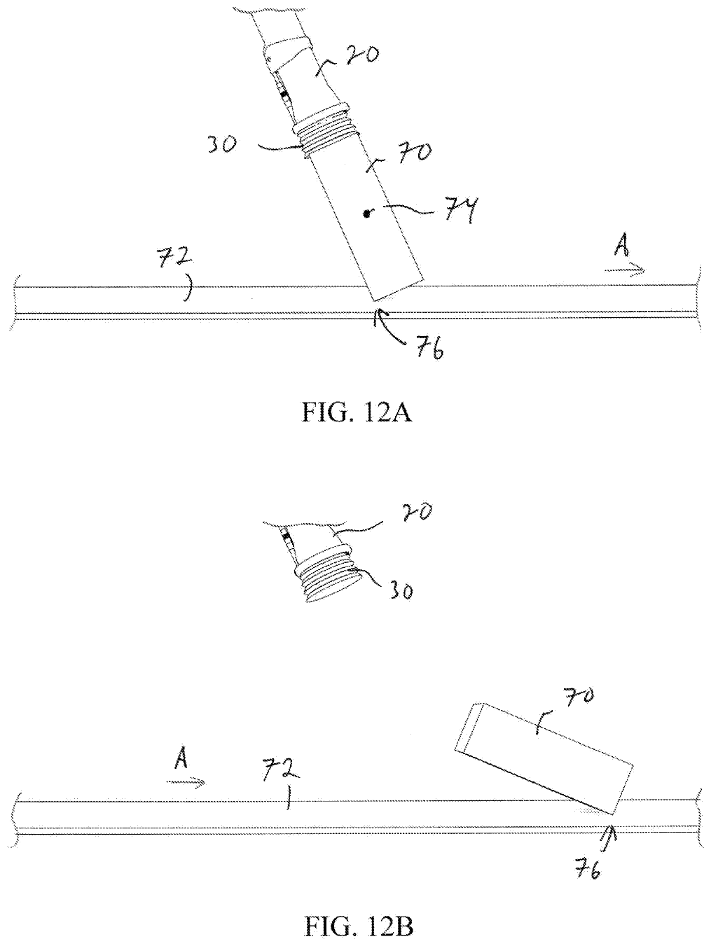

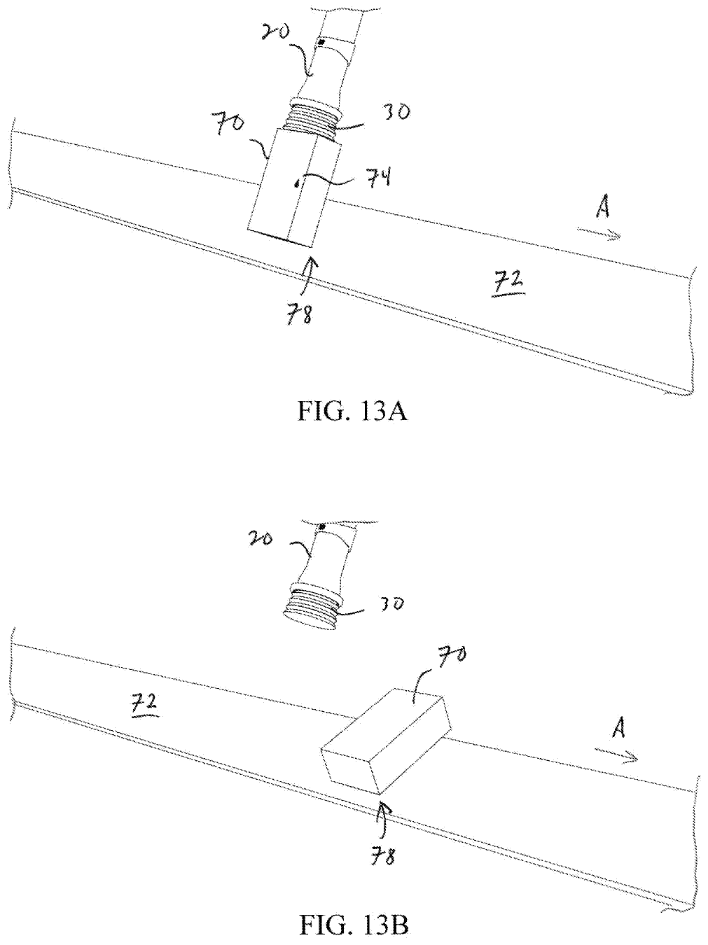

As discussed above, when it is desired to change a pose of an object from a determined pose-in-hand (e.g., SFU to LFU) the system may lay the object in its MFU orientation (e.g., on a medium side). In certain applications however, this may require movement of a significant number of joints of the programmable motion device. With reference to FIGS. 12A-12B, the system may place an object 70 on a belt 72 at an angle determined to provide that a center of mass (CM) of the object (e.g., as shown diagrammatically at 74) is offset by a trailing distance from an area (e.g., line) of contact 76 of the object 70 on the belt 72. With the belt 72 moving as shown at A, the object will fall in a controlled fashion as shown in FIG. 12B in the direction of the trailing distance. FIG. 13A shows the object 70 being placed in a cross-belt direction, and FIG. 13B shows the object falling in a controlled fashion in the cross-belt direction.

For any given object, it may be sufficient to put CM over edge; it is not required to hold the object at 90 degrees to re-orient it. If the object is placed on its the edge, it should topple the rest of the way unless the acceleration of the object as it is placed onto the belt disrupts its fall. In certain applications it is desirable to place the object such that the CM is behind the contact edge in the direction of movement of the belt (FIG. 12A). The object may be placed, for example, such that the CM may be at least one centimeter for smaller objects and at least about 3-5 centimeters for larger objects. In certain applications the distance between CM and the contact edge may be based on the height H of the object as it is being held by the end-effector, such as for example, that the CM is at least 1/10 H to ½ H away from the contact edge.

A strategy therefore may be to place the object at a height at which edge will just touch conveyor, and at either a fixed angle depending on the worst case of H=2W, or an angle that depends on the CM. Both may be chosen to balance execution of trajectory and to minimize bounce. A further strategy may be to re-orient the object a certain number of degrees off of vertical, e.g., about 15 degrees, 20 degrees, 30 degrees or 45 degrees from vertical. Taller items may need less angle but will also tend to fall through a greater total angle, potentially leading to undesirable bouncing and unpredictable behavior. A further strategy may be to fully rotate 90 degrees (or whatever angle is required) to make LFU face parallel to the conveyor.

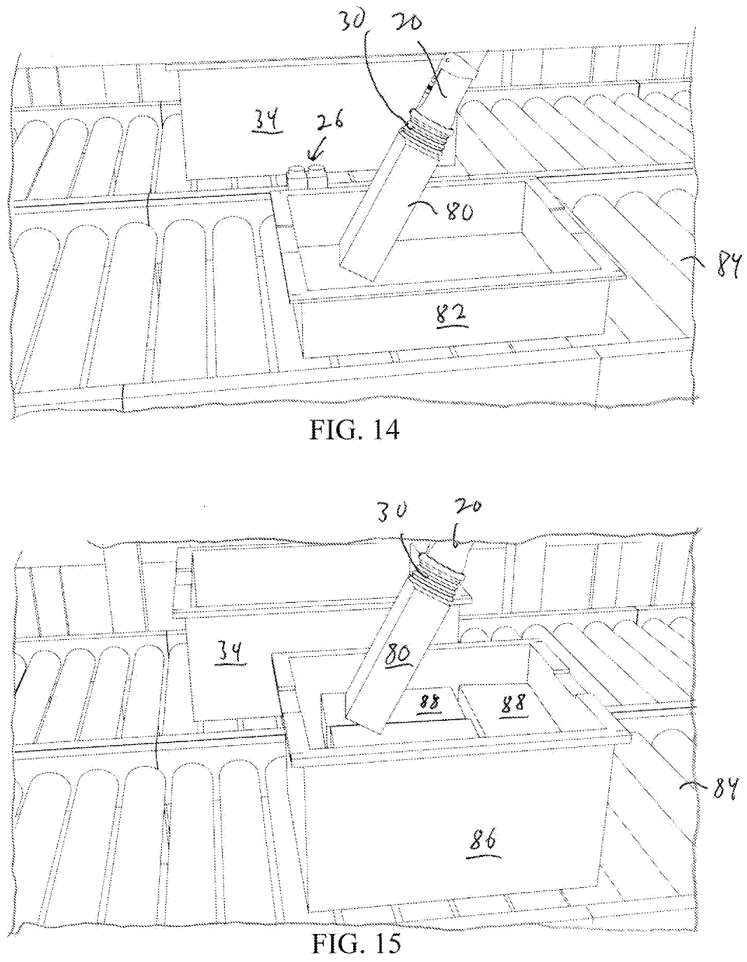

With further reference to FIG. 14 an object 80 may be placed into a bin 82 on a conveyor 84 to initiate a fall in a controlled fashion as discussed above. As shown in FIG. 15, the object may further be placed into a bin 86 that already includes objects 88 such that the object is placed on the other objects 88 in a fashion to initiate a controlled fall onto the objects 88 in the bin 86.

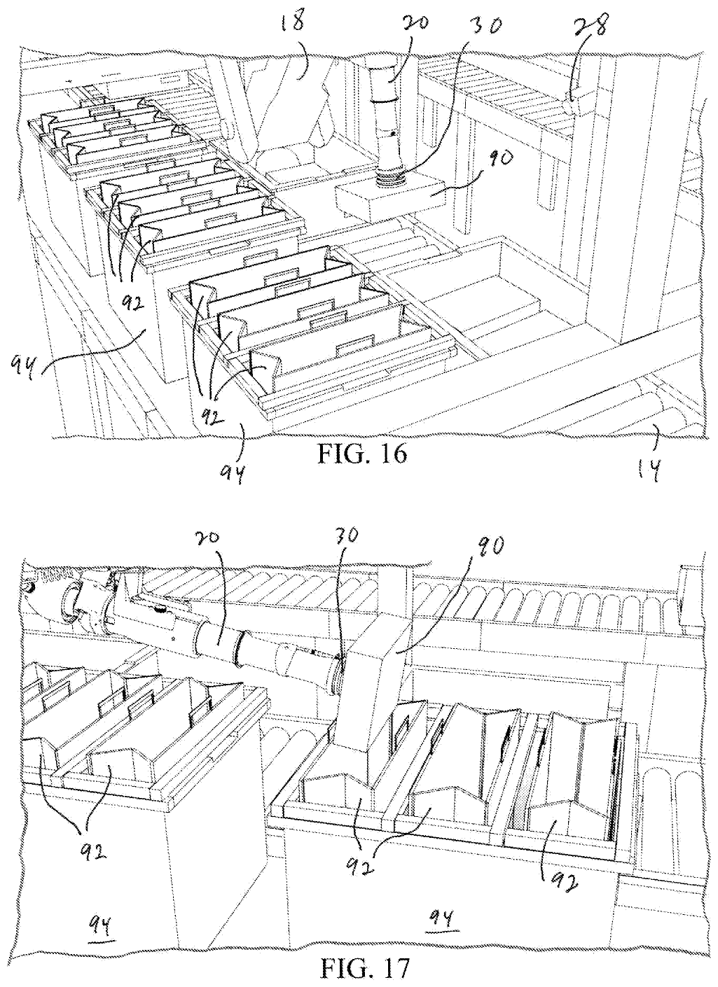

In accordance with further aspects, the pose-in-hand placement pose control system may be used in combination with a bagging station in which objects may need to be positioned in a desired orientation to be placed into one of a plurality of bags. FIG. 16 for example, shows a system in which objects (e.g., 90) are removed from the input container 34 and placed (or dropped) into bags 92 in processing containers 94. When the object 90 is grasped on the MFU (or SFU) surface by the vacuum cup 30 of the end-effector 20 of the programmable motion device 18, the object 90 will fit cleanly into the top opening of a selected bag 92. With reference to FIG. 16 however, when the object 90 is grasped on the LFU surface by the vacuum cup 30 of the end-effector 20 of the programmable motion device 18, the object 90 will not fit cleanly into the top opening of a selected bag 92. The system will identify this based on the pose-in-hand analysis and will rotate the end-effector and the object to position the object 90 such that it will enter the bag opening via its MFU (or alternately its SFU) side as shown in FIG. 17.

Objects are therefore transferred to the pose-in-hand scanning location by the programmable motion device, where the relative pose (orientation and position) of the object in relation to the gripper is determined. Simultaneously, a heightmap is optionally generated of the destination bag. This involves performing point cloud filtering (via clustering/machine learning methods) to remove corner areas that stretch across the corners of the plastic bags. In addition, the edges of the point cloud are filtered out with the expectation that objects will be large enough to be seen even with edge filtering.

Next, candidate object placement poses that will not overfill the container are generated using the heightmap. The system considers both yawing the object to parallel and perpendicular to the bag. If no placements are found, the system rolls the object by 90 degrees and again consider two yaws 90 degrees apart. In all cases, the system aligns the base of the object with the base of the container to minimize bounce dynamics during placement.

Each candidate object placement pose is used to generate corresponding candidate robot place poses. Note that many of these robot place poses (especially for rolled placements) are not feasible. Next, the system concurrently plans in joint space from the pose-in-hand node to TSRs above the candidate robot placement poses. The system also plans from those configurations to the robot place pose candidates in workspace using greedy inverse kinematics and try to get as close as possible to the candidate robot place pose while avoiding collisions.

During rolled placement, the default release may eject the item with considerable force and may make precision placing difficult. The system therefore takes the following steps to reduce the ejection force: 1) Use a decoupled gripper to reduce the gripper spring force, 2) add a one-way valve to the cup to reduce the puff of air that is generated when the valve is opened; 3) harden the bellows to reduce that spring force; and 4) use a multi-stage valve release that quickly opens the valve halfway, then continues to slowly open the valve until the item falls. These measures result is rolled placements that are accurate to −1-2 cm experimentally. A yawing gripper adds an additional degree of freedom that both reduces trajectory durations and decreases planning failures (instances where robot could not find a trajectory given PIH and goal).

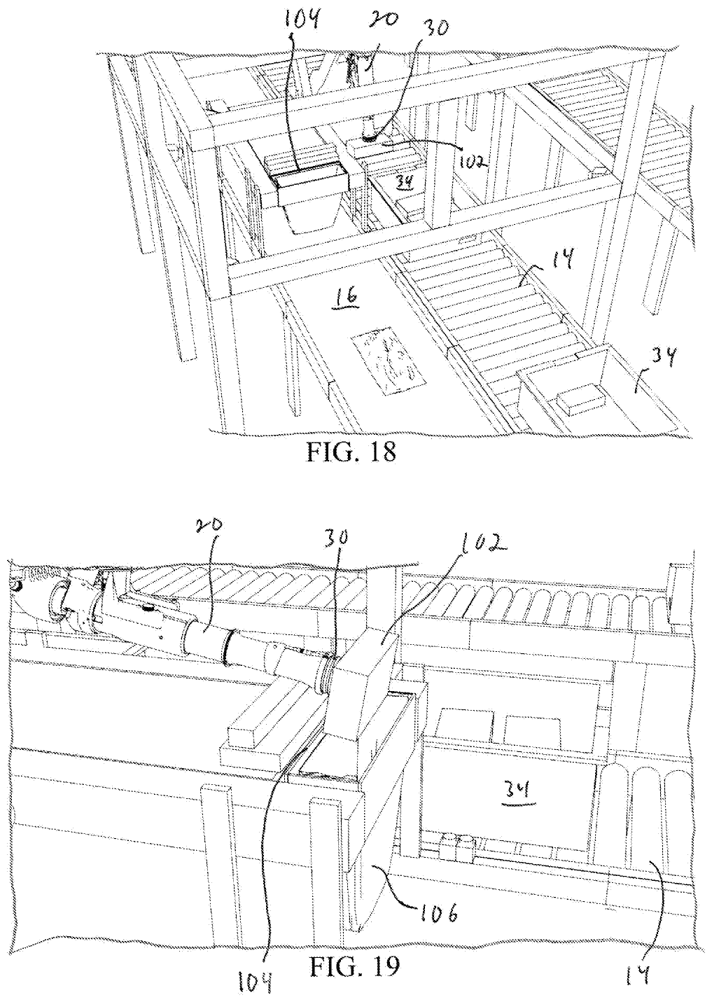

In accordance with yet further aspects, the pose-in-hand placement pose control system may be used in combination with an automated bagging station in which objects may need to be positioned in a desired orientation to be placed into a slot of an automated bagging system (such as a Sharp system sold by Pregis Corporation of NY, NY). The thus formed bags may be shipping packaging (such as an envelope) for non-rigid objects, or the objects themselves may be non-rigid objects within envelopes. FIG. 18 shows a system in which objects (e.g., 02) are removed from the input container 34 and placed (or dropped) into an automated bagging system 104. When the object 102 is grasped on the MFU (or SFU) surface by the vacuum cup 30 of the end-effector 20 of the programmable motion device 18, the object 90 will fit cleanly into the top opening of the automated bagging system 104. With reference to FIG. 19 however, when the object 102 is grasped on the LFU surface by the vacuum cup 30 of the end-effector 20 of the programmable motion device 18, the object 102 will not fit cleanly into the top opening of the automated bagging system 104. The system will identify this based on the pose-in-hand analysis and will rotate the end-effector and the object to position the object 102 such that it will enter the opening of the automated bagging system via its MFU (or alternately its SFU) side as shown in FIG. 19. A bag will be formed about the object as shown at 106 and the bag will be separated from the system 104 and deposited onto the processing conveyance system 16. The object must be oriented correctly to fit into the opening of the automated bagging system and knowing the pose-in-hand as well as the positions of the joints of the device 18 permits the system to achieve this.

In certain applications, the system may try several different poses, but the system may also optionally pull from a continuity (i.e., infinite) number of possible valid poses in some instances. This would give the system more possibilities in case some of the inverse kinematics solutions fail (because of collisions, for instance). Also, some poses that still accomplish the goal of putting objects in a slot/bag/cubby may be faster than one that puts it exactly aligned. The tighter the fit, though, the smaller the satisficing region. When dimension of pose space is small such as just one angle the system may calculate angle limits and discretely sample a range. When pose space (x, y, z, roll, pitch, yaw so 6D), the system may sample randomly around the centered and axis aligned pose. Inverse kinematics may be employed here.

In particular, there may be multiple joint configurations that yield the same pose. Inverse kinematics (IK) typically returns all roots. The inverse kinematics solutions may be found by using forward kinematics to translate from joint space (j₁, j₂, j₃, j₄, j₅, j₆) to gripper pose space (x, y, z, roll, pitch, yaw). The inverse kinematics may translate from the joint space (j₁, j₂, j₃, j₄, j₅, j₆) therefore to any of the following:

$$[ \begin{matrix}j 1 a , j 2 a , j 3 a , j 4 a , j 5 a , j 6 a \\ j 1 b , j 2 b , j 3 b , j 4 b , j 5 b , j 6 b \\ j 1 c , j 2 c , j 3 c , j 4 c , j 5 c , j 6 c \\ j 1 d , j 2 d , j 3 d , j 4 d , j 5 d , j 6 d \\ …\end{matrix} ]$$

Once the inverse kinematics solutions are found, they are then checked against self-collision (robot to itself) and collision with the environment (no part of robot or the item it is holding collides with virtual model of workspace).

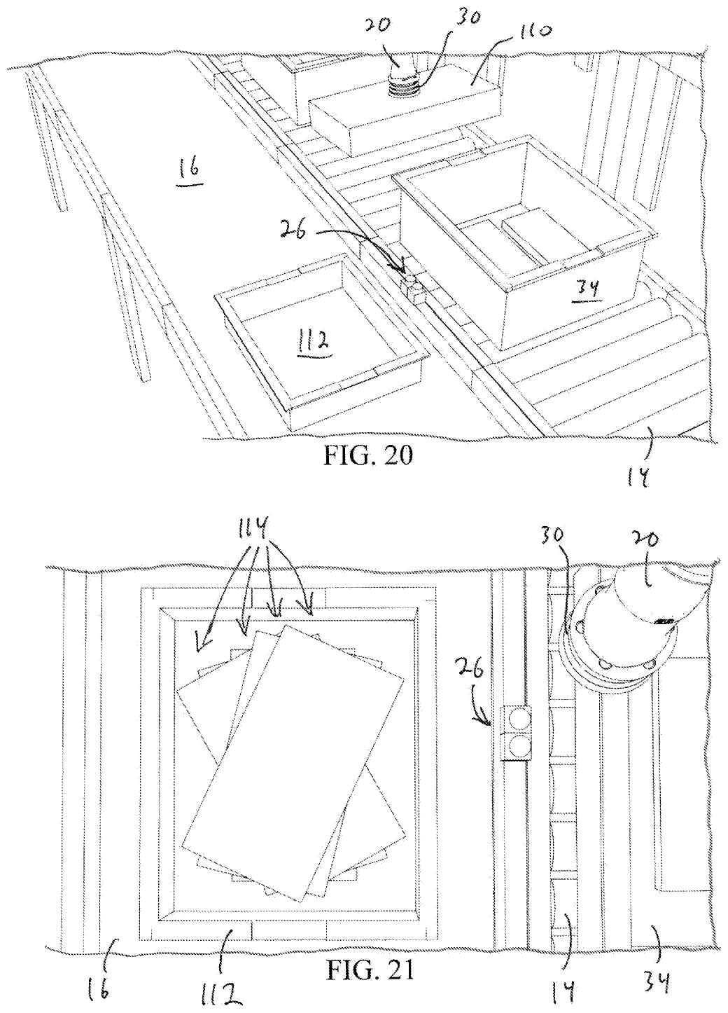

In applications in which objects are placed into containers (e.g., boxes, bins or totes), the system may choose from a set of determined placement poses (or a database of possible placement poses) of the object in the designated container (which placement poses fit). For example, FIG. 20 shows a system in which an object 110 held by the vacuum cup 30 of the end-effector is to be moved to a designated container 112. The permitted placement poses (e.g., as shown at 114) may be known or dynamically determined. There may even be a large (potentially infinite) number of possible valid poses in some instances. This would give the planning system more possibilities in case some of the solutions fail (because of collisions, for instance). Further, some placement poses may accomplish the goal of putting objects in a slot/bag/cubby faster than others that put the object in a position that is exactly aligned (low tolerance). The tighter the fit, though, the smaller the satisficing region. When dimension of placement pose space are small such as just one angle the system may calculate angle limits and discretely sample a range. When placement pose space (x, y, z, roll, pitch, yaw so 6D), the system may sample randomly around the centered and axis aligned pose. In seeking to place an object in a container the system may choose the most efficient orientation that fits the container. As shown in FIG. 21, it may be that many different placement poses are acceptable.

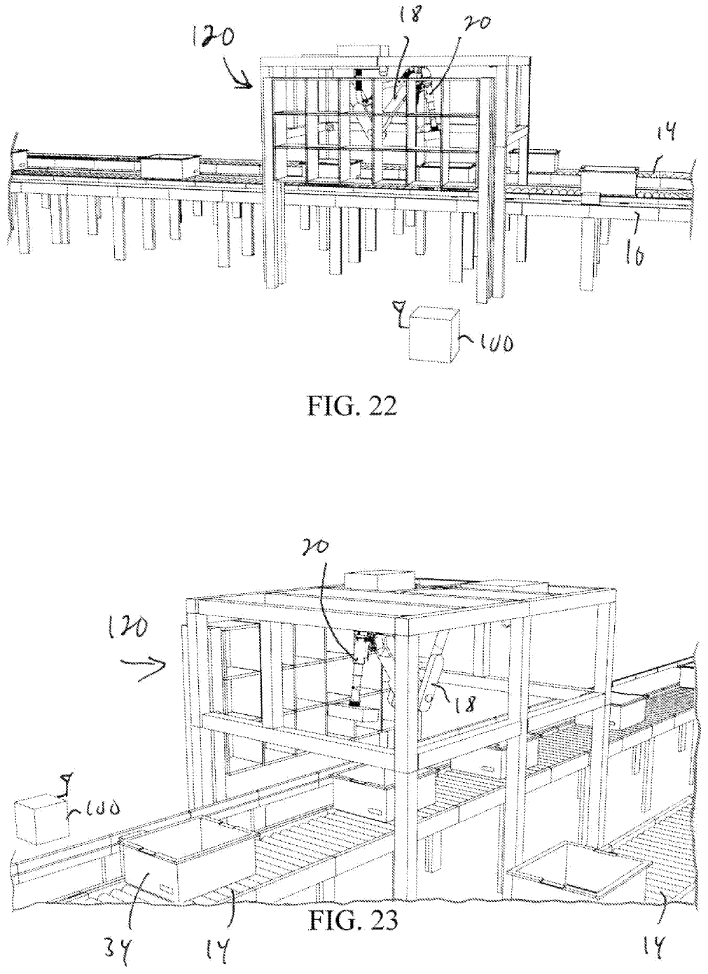

In accordance with further aspects, the object processing system may additionally use the pose-in-hand information to assist in placing objects into vertically stacked cubbies. FIGS. 22 and 23 for example, show a system that includes a vertical array of eighteen cubbies adjacent the processing conveyance system 16. FIG. 22 shows the system from the back showing that the cubbies are open in the back, and FIG. 23 shows the system from the front showing that the cubbies are accessible by the end-effector from the front. Certain of the objects being processed by the object processing system may be selected for placement into one or another of the cubbies (e.g., for processing by human personnel).

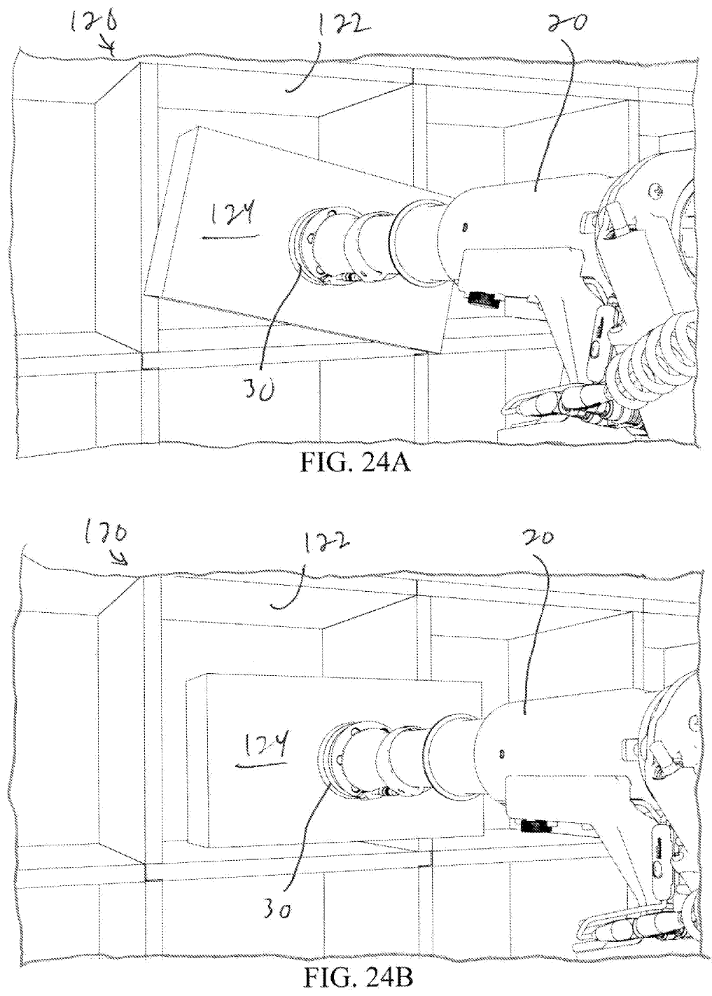

With reference to FIG. 24A, the system uses the pose-in-hand information (together with the device 18 joint information) to know that certain placement approaches to a selected cubbie 122 may not be workable (not fit), while others as shown in FIG. 24B will work. The system has information regarding the sizes and locations of all cubbies and uses the pose-in-hand information to ensure that objects (e.g., object 124) are placed into the cubbies with placement poses that will fit.

In accordance with certain aspects, the system may include applications to a cell where two inventory bins may arrive at the cell (like one of the pack cells). The cell may be specifically designed to do tote consolidation, or tote consolidation may be its part-time job when it is otherwise idle.

In tote consolidation mode, two bins arrive at cell, one is a source and the other is a destination, both may be coming from an AS/RS (automated storage and retrieval system). They may be homogeneous or heterogeneous, and the totes may be subdivided or not. The source bin/subdivision typically has only a few remaining SKUS. In the homogeneous case, the job is to take all remaining SKUs from the source and place them in the destination, presumably with other units of the same SKU. In the heterogeneous case, all units or all units of a given set of SKUs will be transferred from source to destination. The objective is to increase the efficiency of storage in the AS/RS. If two totes in the AS/RS have the same SKU, the system may consolidate those SKUs into one tote to leave room for more SKUs.

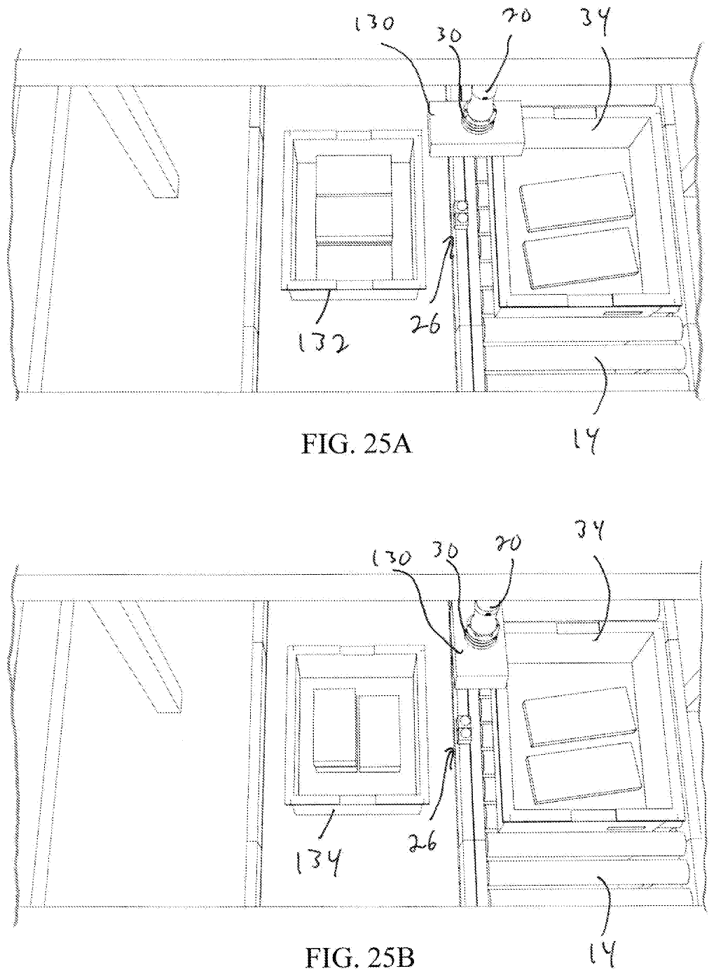

In accordance with certain aspects therefore, the object processing system may additionally use the pose-in-hand information to assist in consolidating objects in containers (e.g., totes or bins), and in managing efficient packing of containers. FIG. 25A shows an object 130 being loaded into a container 132 with like objects that are positioned LFU in a first orientation, and FIG. 25B shows the object 130 being loaded into a container 134 with like objects that are positioned LFU in a second orientation. The pose-in-hand information is used to assist in placing the objects into the containers 132, 134 so as to efficiently pack the containers.

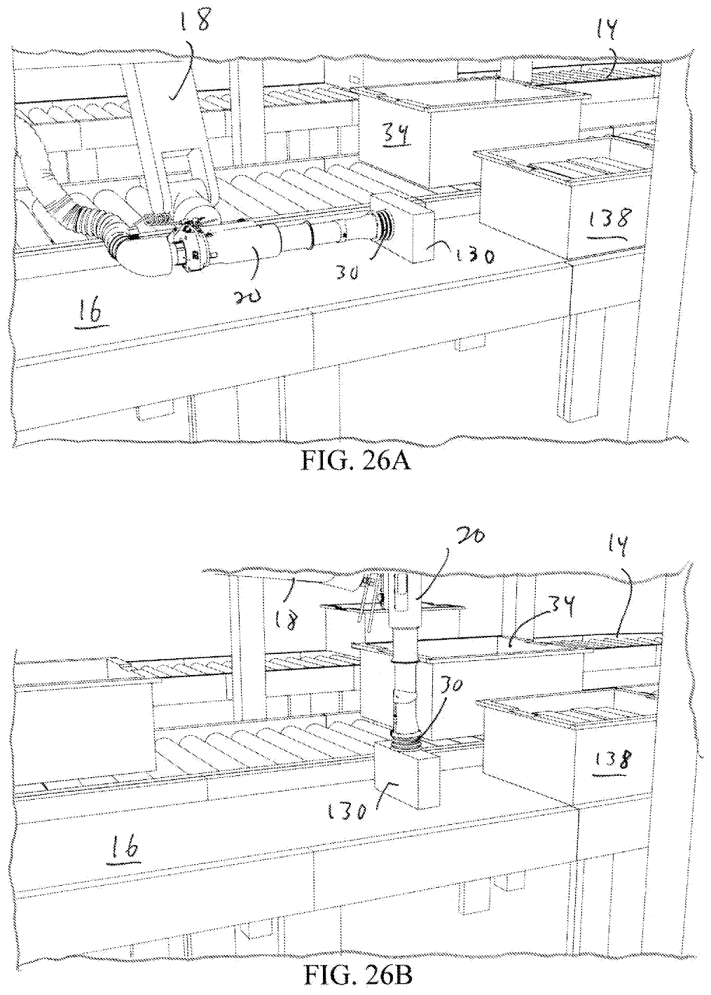

In certain applications however, it may be desired to change the pose-in-hand position of the object on the vacuum cup 30 of the end-effector 20 from, for example, LFU to MFU. FIG. 26A shows the end-effector placing the object onto a support surface (e.g., the belt of the processing conveyance system 16 when stopped), and FIG. 26B shows the vacuum cup 30 of the end-effector 20 re-grasping the object 130, this time from the MFU.

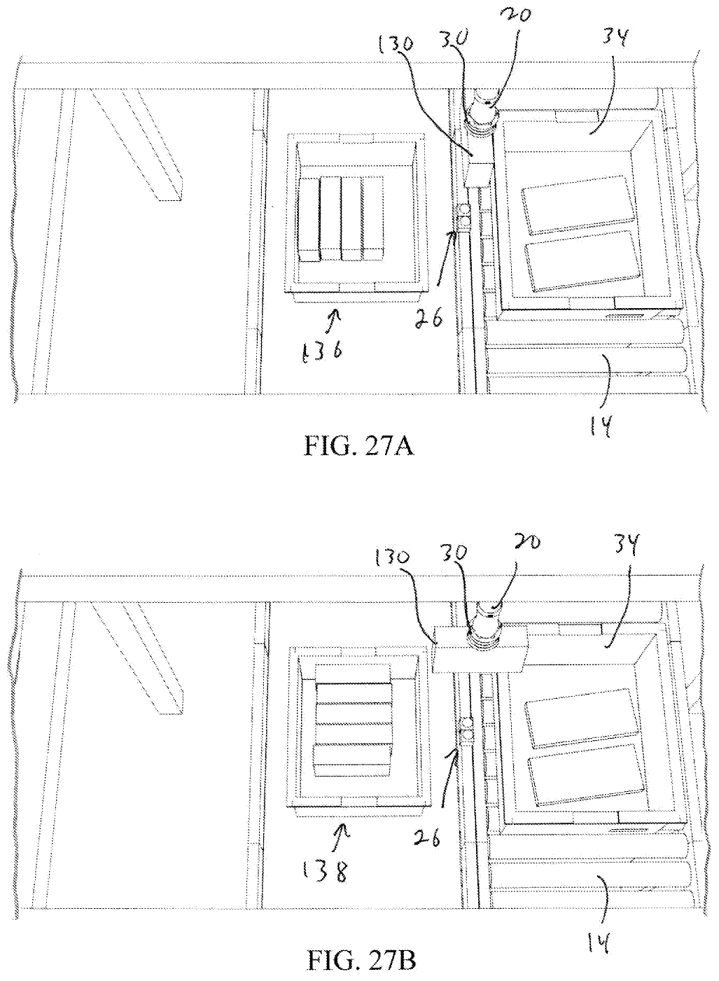

FIG. 27A shows the object 130 being loaded into a container 136 with like objects that are positioned MFU in a first orientation, and FIG. 27B shows the object 130 being loaded into a container 138 with like objects that are positioned MFU in a second orientation. The pose-in-hand information is used to assist in placing the objects into the containers 136, 138 so as to efficiently pack the containers.

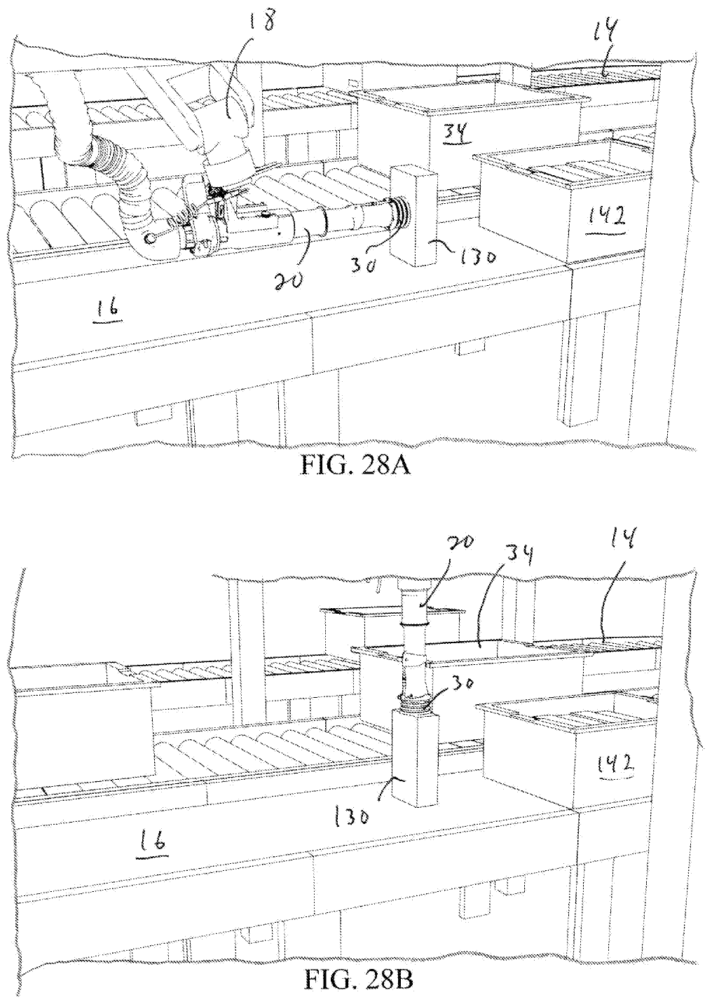

In further applications it may be desired to change the pose-in-hand position of the object on the vacuum cup 30 of the end-effector 20 from, for example, LFU to SFU. FIG. 28A shows the end-effector placing the object onto a support surface (e.g., the belt of the processing conveyance system 16 when stopped), and FIG. 28B shows the vacuum cup 30 of the end-effector 20 re-grasping the object 130, this time from the SFU.

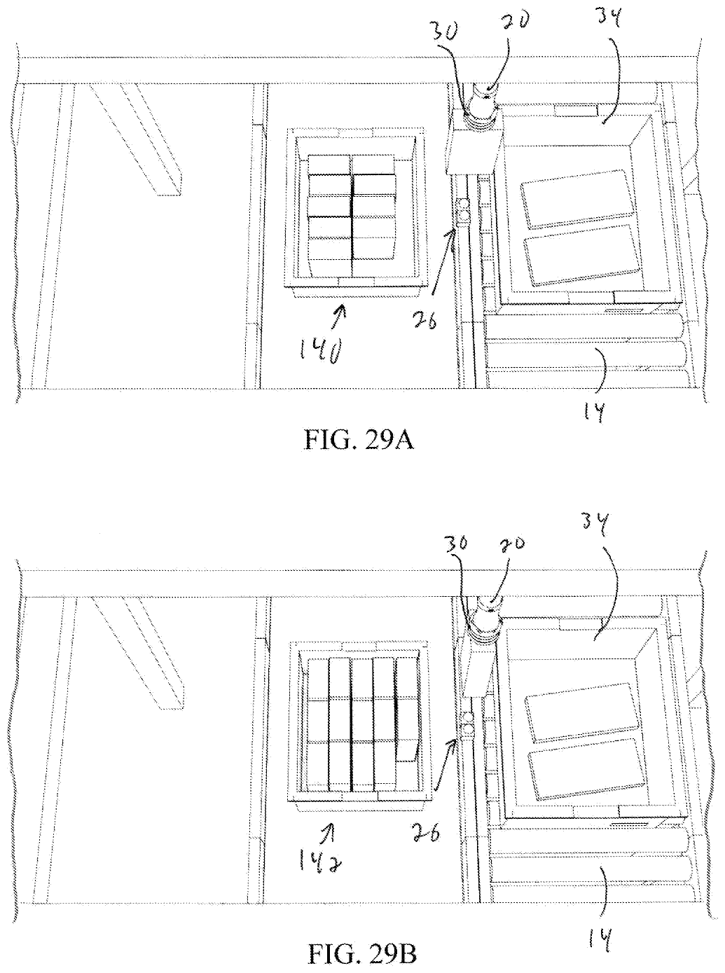

FIG. 29A shows the object 130 being loaded into a container 140 with like objects that are positioned SFU in a first orientation, and FIG. 29B shows the object 130 being loaded into a container 142 with like objects that are positioned SFU in a second orientation. The pose-in-hand information is used to assist in placing the objects into the containers 140, 142 so as to efficiently pack the containers. As may be seen from comparisons of the LFU, MFU and SFU consolidations, packing with SFU may provide the most number of objects in a container.

In accordance with various aspects therefore, the system may perform the steps of scanning an input container, picking an object from the input container with a gripper, performing pose-in-hand perception analyses on the object while being held by the gripper, scanning a destination container with a 3D scanner, performing a pack plan per pack planning work given the pose-in-hand of the object, placing the object and repeating. Exceptions include: if double pick, detect it with scales or PIH as per usual; if drop, call for intervention; and if conveyor jam, call for intervention.

What is claimed is:

1. A method of processing objects, said method comprising:
grasping an object with an end-effector of a programmable motion device;
determining an estimated pose of the object as it is being grasped by the end-effector;
determining a pose adjustment for repositioning the object for placement at a destination location in a destination pose;
determining a pose adjustment to be applied to the object; and
placing the object at the destination location in a destination pose in accordance with the pose adjustment.

2. The method as claimed in claim 1, wherein the method further includes determining joint positions of each of a plurality of joints of the programmable motion device.

3. The method as claimed in claim 2, wherein the joint positions are associated with the estimated pose.

4. The method as claimed in claim 3, wherein the joint positions are determined when the end-effector is positioned at a pose-in-hand location.

5. The method as claimed in claim 3, wherein the joint positions are estimated joint positions determined by interpolation.

6. The method as claimed in claim 1, wherein the determining an estimated pose of the object is performed while the end-effector is moving.

7. The method as claimed in claim 1, wherein the determining the pose adjustment includes determining a topple risk factor.

8. The method as claimed in claim 1, wherein the placing the object at the destination location in the destination pose involves positioning the object with the end-effector such that a center of mass of the object is outside of a contact area at which the object contacts the destination location.

9. The method as claimed in claim 1, wherein the placing the object at the destination location in the destination pose involves moving the end-effector at least about 15 degrees from vertical prior to releasing the object to the destination location.

10. The method as claimed in claim 1, wherein the determining the pose adjustment includes determining any of a largest face, smallest face or other face of the object to be facing up when placed at the destination location.

11. The method as claimed in claim 1, wherein the adjusting the pose of the object responsive to the pose adjustment involves re-grasping the object.

12. The method as claimed in claim 11, wherein the re-grasping the object involves re-grasping the object on a face of the object that is different than an initial face on which the object was initially grasped.

13. The method as claimed in claim 1, wherein the adjusting the pose of the object responsive to the pose adjustment involves placing the object onto a repositioning surface.

14. The method as claimed in claim 13, wherein the repositioning surface is a portion of a conveyor.

15. The method as claimed in claim 13, wherein the placing the object on the receiving surface involves causing the object to be tipped over on the receiving surface.

16. The method as claimed in claim 1, wherein the destination location includes a bag, and the pose adjustment involves aligning opposing sides of the object with inner side walls of an opening to the bag.

17. The method as claimed in claim 1, wherein the destination location includes a slot, and the pose adjustment involves aligning opposing sides of the object with inner side walls of the slot.

18. The method as claimed in claim 1, wherein the destination location includes a cubbie, and the pose adjustment involves aligning opposing sides of the object with side walls of the cubbie.

19. A method of processing objects, said method comprising:
grasping an object with an end-effector of a programmable motion device;
determining an estimated pose of the object as it is being grasped by the end-effector;
determining estimated joint positions of a plurality of the joints of the programmable motion device associated with the estimated pose of the object;
associating the estimated pose with the estimated joint positions to provide placement pose information; and
placing the object at the destination location in a destination pose based on the placement pose information.

20. The method as claimed in claim 19, wherein the joint positions are determined when the end-effector is positioned at a pose-in-hand location.

21. The method as claimed in claim 19, wherein the joint positions are estimated joint positions determined by interpolation.

22. The method as claimed in claim 19, wherein the determining an estimated pose of the object is performed while the end-effector is moving.

23. The method as claimed in claim 19, wherein the determining the pose adjustment includes determining a topple risk factor.

24. The method as claimed in claim 19, wherein the placing the object at the destination location in the destination pose involves positioning the object with the end-effector such that a center of mass of the object is outside of a contact area at which the object contacts the destination location.

25. The method as claimed in claim 19, wherein the placing the object at the destination location in the destination pose involves moving the end-effector at least about 15 degrees from vertical prior to releasing the object to the destination location.

26. The method as claimed in claim 19, wherein the determining the estimated pose includes determining any of a largest face, smallest face or other face of the object to be facing up when placed at the destination location.

27. The method as claimed in claim 19, wherein the placement pose information includes information relating to re-grasping the object.

28. The method as claimed in claim 27, wherein the re-grasping the object involves re-grasping the object on a face of the object that is different than an initial face on which the object was initially grasped.

29. The method as claimed in claim 19, wherein the placing the object on the receiving surface involves causing the object to be tipped over on the receiving surface.

30. The method as claimed in claim 19, wherein the destination location includes a bag, and the pose adjustment involves aligning opposing sides of the object with inner side walls of an opening to the bag.

31. The method as claimed in claim 19, wherein the destination location includes a slot, and the pose adjustment involves aligning opposing sides of the object with inner side walls of the slot.

32. The method as claimed in claim 19, wherein the destination location includes a cubbie, and the pose adjustment involves aligning opposing sides of the object with side walls of the cubbie.

33. An object processing system for processing objects comprising:
an end-effector of a programmable motion device for grasping an object;
at least one pose-in-hand perception system for assisting in determining an estimated pose of the object as held by the end-effector;
a control system for determining estimated joint positions of a plurality of the joints of the programmable motion device associated with the estimated pose of the object, and for associating the estimated pose with the estimated joint positions to provide placement pose information; and
a destination location at which the object is placed in a destination pose based on the placement pose information.

34. The object processing system as claimed in claim 33, wherein the joint positions are determined when the end-effector is positioned at a pose-in-hand location.

35. The object processing system as claimed in claim 33, wherein the joint positions are estimated joint positions determined by interpolation.

36. The object processing system as claimed in claim 33, wherein the estimated pose of the object is performed while the end-effector is moving.

37. The object processing system as claimed in claim 33, wherein the control system further determines a topple risk factor.

38. The object processing system as claimed in claim 33, wherein the object processing system positions the object with the end-effector such that a center of mass of the object is outside of a contact area at which the object contacts the destination location.

39. The object processing system as claimed in claim 33, wherein the object processing system positions the object with the end-effector at least about 15 degrees from vertical prior to releasing the object to the destination location.

40. The object processing system as claimed in claim 33, wherein the object processing system further determines any of a largest face, smallest face or other face of the object to be facing up when placed at the destination location.

41. The object processing system as claimed in claim 33, wherein the placement pose information includes information relating to re-grasping the object.

42. The object processing system as claimed in claim 40, wherein the re-grasping the object involves re-grasping the object on a face of the object that is different than an initial face on which the object was initially grasped.

43. The object processing system as claimed in claim 33, wherein the placing the object on the receiving surface involves causing the object to be tipped over on the receiving surface.

44. The object processing system as claimed in claim 33, wherein the destination location includes a bag, and the pose adjustment involves aligning opposing sides of the object with inner side walls of an opening to the bag.

45. The object processing system as claimed in claim 33, wherein the destination location includes a slot, and the pose adjustment involves aligning opposing sides of the object with inner side walls of the slot.

46. The object processing system as claimed in claim 33, wherein the destination location includes a cubbie, and the pose adjustment involves aligning opposing sides of the object with side walls of the cubbie.
